(19) United States
(12) Patent Application Publication
(10) Pub. No.: US 2010/0296742 A1
(43) Pub. Date: Nov. 25, 2010

(54) SYSTEM AND METHOD FOR OBJECT BASED POST EVENT FORENSICS IN VIDEO SURVEILLANCE SYSTEMS

(75) Inventors: Jayaprakash Chandrasekaran, Madurai (IN); Balaji Badhey Sivakumar, Madurai (IN); Sachin J, Kannur (IN)

Correspondence Address: HONEYWELL/HUSCH;Patent Services, 101 Columbia Road, P.O.Box 2245, Morrlstown, NJ, 07962, US

(73) Assignee: Honeywell Inernational Inc., Morristown, NJ (US)

(21) Appl. No.: 12/470,673

(22) Filed: May 22, 2009

(51) Int. Cl. G06K 9/68; G08B 21/00; H04N 7/18

(52) U.S. Cl. 382/218; 340/540; 348/159; 348/E07.085

(57) ABSTRACT

An object can be specified using active contour modeling. That representation can be stored. A sequence of images can be automatically reviewed to determine if the object can, in some form or state, be detected in one or more of the images. One or more alarms can generated in response to determining the presence or absence of the object from the sequence of images.

### FIELD

The invention pertains to video surveillance systems. More particularly, the invention pertains to such systems and methods which provide automatic reviewing of previously collected video information.

### BACKGROUND

During the past several years an awareness of intelligent security has become wide spread and video surveillance has become an integral part of it. Video surveillance is currently employed at many premises. The required premises area is monitored with one or more cameras and the resultant video output is recorded in digital storage media.

This wealth of video information can be used in postmortem analysis. Such postmortem analysis of theft situations requires navigating and monitoring through the entire video from the beginning till that instant when the valuable item is lost, to find out the when it was stolen. The huge data of video information has to be processed manually to identify clues or information about a theft. This can be a time consuming and a tedious process. There is thus a need to automate such searches to save time and effort in searching for items of interest (objects) in the stored video.

### BRIEF DESCRIPTION OF THE DRAWINGS

FIG. 1 is a block diagram of a system which embodies the present invention;

FIG. 2 is a flow diagram which illustrates a method of object detection;

FIG. 3 is a flow diagram which illustrates a method of automatically reviewing a video sequence; and

FIGS. 4A-4D illustrate screens displayed by a graphical user interface of the system of FIG. 1 while processing images for objects in accordance with the methods of FIGS. 2, 3.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the present method search and locate items of interest presented as images in various states. In the present method, the items of interest (objects) are marked by a user in an image, for example a video frame, where the entire item is present. The properties of the selected item like shape and color are identified and stored.

In an aspect of the invention, a search operation can be carried out starting at an initial, or, specified time of an image sequence, for example a video sequence that has been acquired or recorded over a selected time interval, using the stored properties. An item (object) of interest can in a disclosed embodiment, be uniquely specified by using Snake-type object detection processing. Processing in accordance with the invention will identify the object's available, lost and partial occlusion states. Based on an object's availability or state, for example if the object is not present in the scene, or if the object is hidden partially, an alarm can be generated and an image, or video snapshot displayed for the user.

Searching and locating the items of interest can be done automatically. The changes in state of the items of interest can be identified and displayed for the user. Embodiments of the invention can be used to carry out post mortem analysis of a crime scene by searching for items of interest in pre-stored video sequences. Alternately, video surveillance and tracking of items, or objects can be implemented.

It will be understood that different types of active contour models can be used in specifying objects initially, and in specifying representations of such objects subsequently. Other forms of object detection processing which can detect object shapes can also be used without departing from the spirit and scope of the invention. Similarly, various metrics can be used to establish a degree of similarity between the initial specification of an object and the subsequent specification of an image, which might be all or a portion of the same object, also without departing from the spirit and scope of the invention. An exemplary form of such processing, and associated metric, are disclosed in published US patent application No. 2007/0140531 published Jun. 21, 2007, entitled “Standoff Iris Recognition System” which is assigned to the assignee hereof and incorporated by reference.

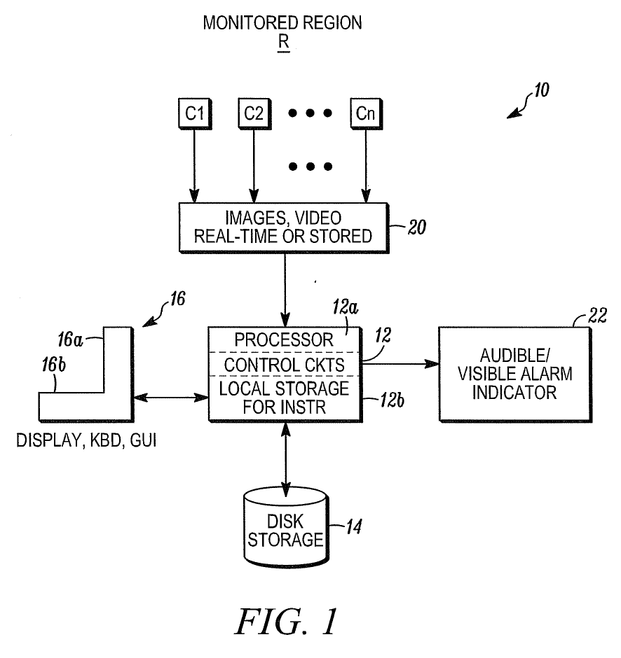

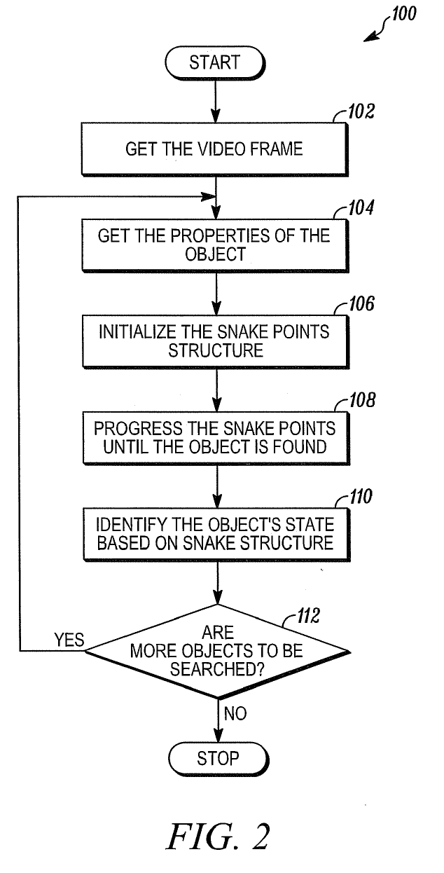

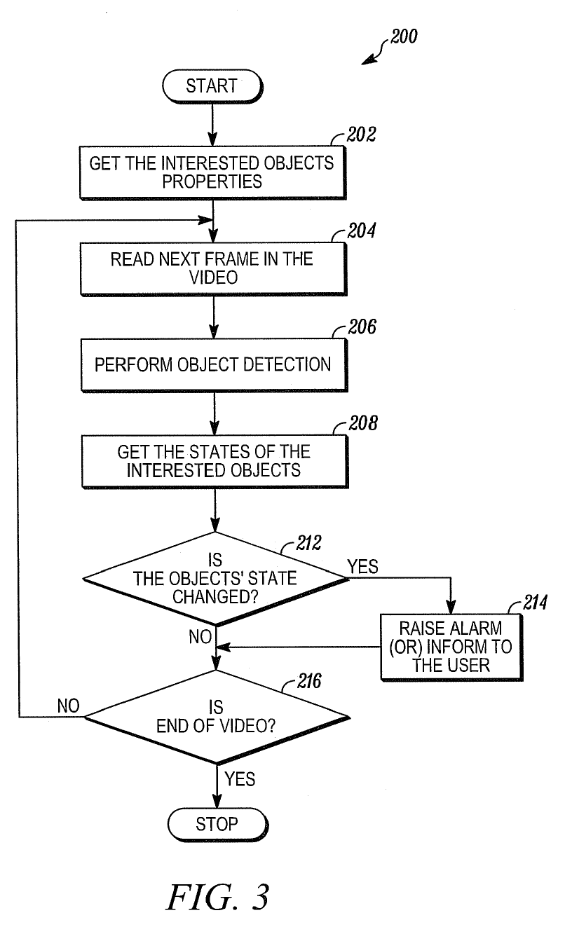

FIG. 1 illustrates a system 10 which embodies the invention. System 10 can include control circuits 12 which could be implemented at least in part with one or more programmable processors 12a. Local computer readable storage circuits, or memory, 12b can be used to store instructions to be executed by processor 12a in implementing processes, or methods discussed subsequently and illustrated in FIGS. 2, 3.

Local mass storage unit 14, a magnetic or optical disk drive, can be used by processor 12a as a read/write computer readable storage medium where image processing information such as one or more data bases, control programs and the like can be stored and accessed by the processor 12a. A graphical user interface 16 (GUI) can include a display device 16a, a user communication device 16b, such as a keyboard and associated control software, stored in the memory unit 12b.

A source of images 20, either pre-stored on one or more computer readable storage units or memory units or provided in real-time from one or more camera units C1, C2 . . . Cn can be coupled to the control circuits for analysis as in FIGS. 2,3 discussed subsequently. It will be understood that the cameras C1 . . . Cn have fields of view directed to a monitored region R. An alarm indicating device 22, audible or visual, can be coupled to control circuits 12 in addition to the display 16a.

FIG. 2 is a flow diagram 100 of a method of item, or object detection implemented by the control circuits 12 in combination with executable instructions or software stored on the computer readable storage unit 12b. An image from a sequence, for example a video frame, is acquired as at 102. Object properties are acquired, as at 104. Snake-type specification or identification processing is carried out as at 106, 108. An object's state can be identified based on the previously established snake structure as at 110. The state information can be stored for subsequent use. The process can be repeated, as at 112 if additional objects are to be searched.

FIG. 3 is a flow diagram of automated processing 200 for detection of a change of state of an item or object. Properties or characteristics of an item or object of interest can be acquired from storage, or off of an initial image, as at 202. The next image or frame can then be acquired, for example from storage unit 20, as at 204.

Object detection, as in FIG. 2 can then be performed, as at 206. Initial, or earlier object state, or states and current state or states can be acquired as at 208. The state of the object can be evaluated, using one more metrics, as at 212. An alarm can be generated via the graphical user interface 16 or alarm output device 22, as at 214, if a change of state has been detected. If no change of state has been detected in the present image, and more images are available, the process can be repeated, as at 216.

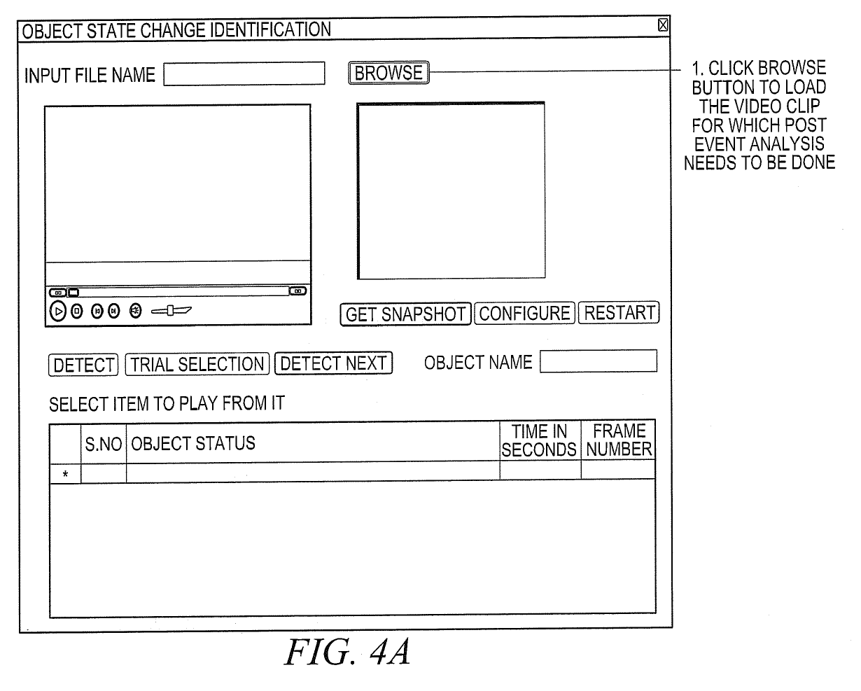

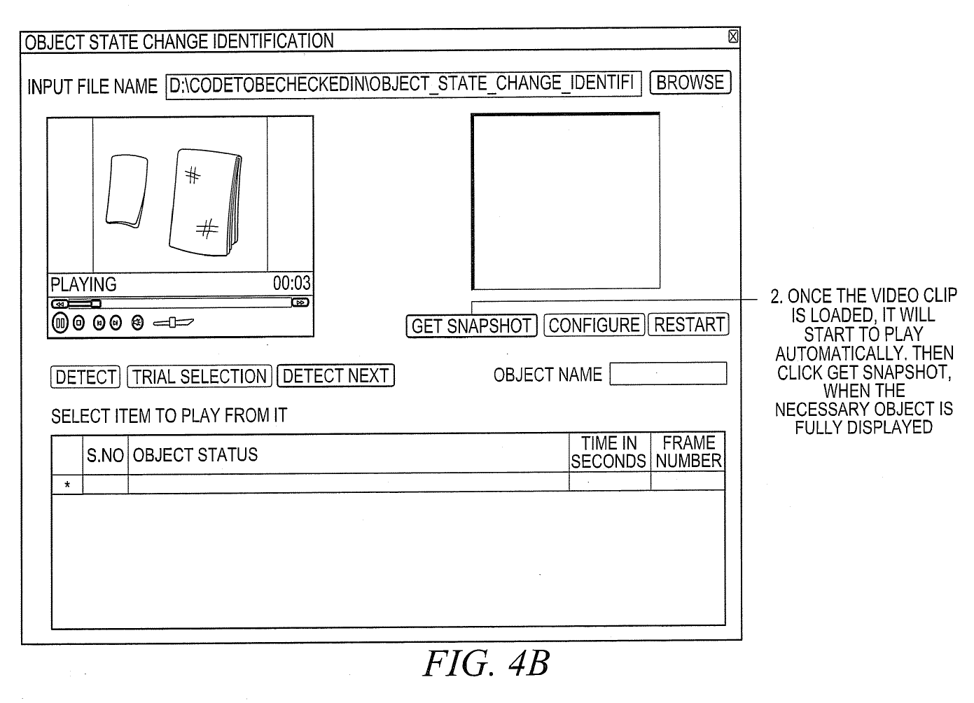

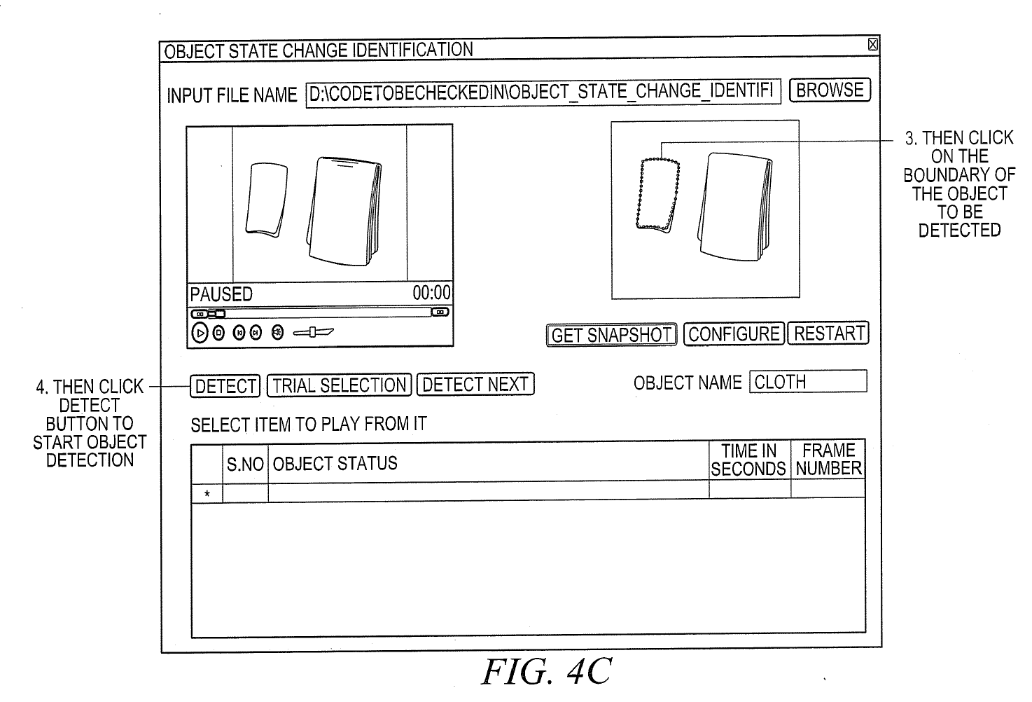

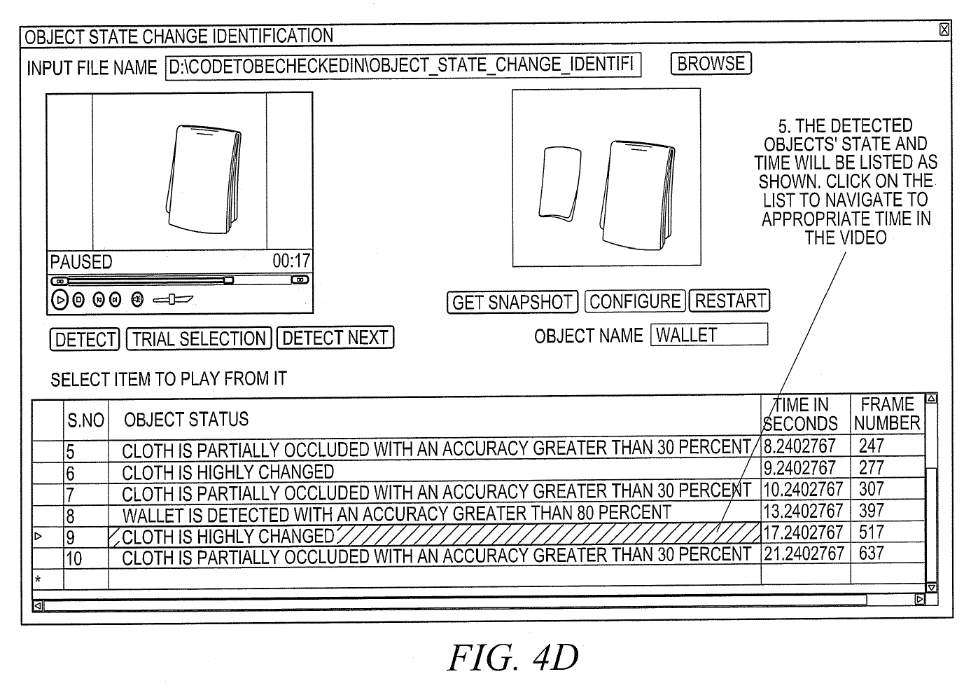

FIGS. 4A-4D illustrate some of the displays, or screens, presentable to a user via the graphical user interface 16 and display device 16a. As illustrated in FIG. 4A, a “Browse” button can be selected or clicked on to load a video sequence from the storage unit 20. As illustrated in FIG. 4B, when an object of interest is displayed on an image, that image can be acquired for processing by activating or clicking on the “Snapshot” light button.

As illustrated in FIG. 4C, the boundary of the selected object can be specified in the snapshot by the user. Object detection can then be initiated for each of a subsequently acquired set of images by activating or clicking on the “Detect” button. The items, or objects that are found in the set of images can be listed, and or displayed as illustrated in FIG. 4D. Both object state and associated time can also be displayed.

Those of skill will understand that the word “video” as used herein relates to one or more multi-dimensional images such as could be acquired from a solid state camera, without regard to output format, or known types of cameras which can to produce multi-frame images in analog or digital format which could be presented visually on monitors or television-type output devices, without limitation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A method comprising:
obtaining an image of an object to be monitored;
establishing shape based physical characteristics of the object at or about a first time;
storing the established characteristics in a computer readable storage medium selected from a class which includes semiconductor storage devices, magnetic storage devices, and optical storage devices;
receiving an image associated with a second, subsequent time of a portion of a region being monitored;
establishing shape based physical characteristics of at least one object in the image associated with the second time;
retrieving the stored, established characteristics from the storage medium, and, determining how the stored, established characteristics relate to the established characteristics associated with the second time.

2. A method as in claim 1 where establishing the characteristics associated with the first time comprises carrying our at least one of forming a shape based representation of the object, forming a pattern based representation of the object, or, carrying out fuzzy logic processing of the object.

3. A method as in claim 1 where establishing includes carrying out edge tracking of the object

4. A method as in claim 1 where detecting includes carrying out at least one of shape based comparison processing, pattern recognition, or fuzzy logic processing.

5. A method as in claim 2 where detecting includes carrying out at least one of shape based comparison processing, pattern recognition, or fuzzy logic processing.

6. A method as in claim 4 which includes, responsive to the detecting, generating an alarm indicative of a detected difference between the images.

7. A method as in claim 4 which includes obtaining a sequence of images, generated at a plurality of times about or later than the second time, and establishing shape based-physical characteristics of at least one object in respective ones of the images.

8. A method as in claim 7 which includes, responsive to the detecting, generating an alarm indicative of a detected difference between the images.

9. An apparatus comprising:
control circuits having an input port to receive a sequence of video-type images where the control circuits can carry out shape detection of at least one selected object in a respective image and store object specifying indicia in a computer readable storage medium;
instructions, stored on a computer readable storage medium, executable by the control circuits to scan a plurality of images for at least one item, to carry out shape detection thereof, and further instructions to evaluate differences in state between the selected object and the at least one item.

10. An apparatus as in claim 9 which includes a graphical user interface and instructions, stored on a computer readable storage medium, executable by the control circuits to present an image of the object on a display device and receive object boundary identifying information manually entered through the display device.

11. An apparatus as in claim 9 which includes additional executable instructions, responsive to differences in state between the selected object and the at least one item to produce at least one of a visual or an audible output indicative thereof.

12. An apparatus as in claim 11 which includes instructions, stored on a computer readable storage medium, to carry out active contour-type modeling to detect the shape of the object.

13. An apparatus as in claim 12 where the control circuits include at least one programmable processor which executes the instructions stored on the computer readable storage medium.

14. An apparatus as in claim 13 which includes a multi-dimensional display device coupled to the processor on which a user can manually specify a boundary of an object to be detected.

15. An apparatus as in claim 14 which includes a plurality of cameras, to monitor a region, coupled to the control circuits.

16. Software stored on a computer readable storage medium, the software when executed carries out:
active contour modeling of a selected object to establish a representation thereof;
storing of the representation;
scanning a sequence of images, and carrying out active contour modeling of at least one item detected in at least one of the images of the sequence and establishing a representation thereof; and
determining if a relationship is present between the representation of the selected object and the representation of the at least one item.

17. Software as in claim 16 which enables a user to specify a boundary of the selected object.

18. Software as in claim 17 where determining includes establishing a difference in state between the object and the at least one item.
